(19) United States
(12) Patent Application Publication
(10) Pub. No.: US 2010/0169702 A1
(43) Pub. Date: Jul. 1, 2010

(54) MEMORY CONTROL APPARATUS, MEMORY OPTIMIZATION PROGRAM PRODUCT, AND MEMORY OPTIMIZATION METHOD

(75) Inventor: Yoshihiko Takeda, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/645,417

(22) Filed: Dec. 22, 2009

(30) Foreign Application Priority Data
Dec. 26, 2008 (JP) 2008-335255

(51) Int. Cl. G06F 1/06

(52) U.S. Cl. 713/600

(57) ABSTRACT

According to one embodiment, a memory control apparatus includes a generator configured to delay a clock signal having a rise and a fall that appear in a constant cycle and to generate a plurality of delay clock signals having delay times different from each other; an extractor configured to extract, from a data signal including reference data, data of a portion corresponding to the rise or fall of each delay clock signal generated; a first determiner configured to determine whether each data extracted coincides with the reference data; and a second determiner configured to determine, from the delay times of the delay clock signals corresponding to the data that have been determined to coincide, a range of the delay time with respect to the rise of the clock signal and a range of the delay time with respect to the fall of the clock signal.

### CROSS-REFERENCE TO RELATED APPLICATIONS

This application is based upon and claims the benefit of priority from Japanese Patent Application No. 2008-335255, filed Dec. 26, 2008, the entire contents of which are incorporated herein by reference.

### BACKGROUND

1. Field

One embodiment of the invention relates to a memory control apparatus, a memory optimization program, and a memory optimization method.

2. Description of the Related Art

As a high-speed memory, a double data rate synchronous dynamic random access memory (DDR-SDRAM) has been used in a computer system recently. The DDR-SDRAM causes a memory control apparatus to receive a data signal (hereinafter, “DQ signal”) synchronized with both a rise edge and a fall edge of a data strobe signal (hereinafter, “DQS signal”). In the DDR-SDRAM, the memory control apparatus appropriately receives data from the DQ signal, based on both the rise edge and the fall edge of the DQS signal.

Conventionally, as means for optimally setting a timing to receive the data from the DQ signal, for example, the configuration illustrated in FIG. 22 has been used. FIG. 22 is an example of the entire configuration of a conventional memory optimization setting system. As illustrated in FIG. 22, the memory control apparatus acquires the DQ signal and the DQS signal from the DDR-SDRAM. The DQS signal has a rise edge and a fall edge. The memory control apparatus receives data from the DQ signal superimposed with the data, at reception timings corresponding to the rise edge and the fall edge. The memory control apparatus needs to delay the DQS signal from the DQ signal in order to receive the data within an effective region (readable range) of the DQ signal superimposed with the data. The delayed time is set in a read parameter register of the memory control apparatus by a CPU. Thereby, the DQS signal in the memory control apparatus is delayed according to a value of the read parameter register. In the read parameter register, a drive strength value, which indicates the strength of the DQ signal and the DQS signal and changes the timing at which the DQ signal is received, is also set.

An example of an optimal delay of the DQS signal will be described with reference to FIG. 23. The memory control apparatus receives the data from the DQ signal at the timings corresponding to the rise edge and the fall edge of the DQS signal. However, for a predetermined period of time before and after the rise edge and the fall edge of the DQS signal, the DQ signal needs to be stable. A period of time for which the DQ signal needs to be stable before an edge is called a setup time, and a period of time for which the DQ signal needs to be stable after an edge is called a hold time. In the example of FIG. 23, in order to infallibly receive the data from the DQ signal at the rise edge of the DQS signal, the memory control apparatus delays the DQS signal by the delay time in FIG. 23 to cause the center of the rise edge to be positioned at a boundary between the setup time and the hold time, and thus to optimally secure a timing margin for receiving the DQ signal.

However, in the memory control apparatus, because of the presence of multiple sources of the DDR-SDRAMs, different voltage environments due to variation in power circuits mounted in the DDR-SDRAMs, and variation in manufacture of the DDR-SDRAMs, variation is generated in reception timing of the DQ signal. Further, in the memory control apparatus, because of different signal characteristics due to temperature environment of the DDR-SDRAM, variation is generated in the reception timing of the DQ signal. Furthermore, in the memory control apparatus, due to variation in manufacture of the memory control apparatus, a variation is generated in the reception timing of the DQ signal. For this reason, in the memory control apparatus, it is difficult to optimize the reception timing of the DQ signal.

Accordingly, practically, in order to allow the memory control apparatus to optimize the reception timing of the DQ signal, when an apparatus is designed, timing characteristics of a plurality of DDR-SDRAMs are measured for a plurality of temperature conditions, and an intermediate value of the measured timing characteristics is set in a read parameter register.

Another technology has been disclosed, in which a specific value is written in a specific address of DDR-SDRAM beforehand, and the memory control apparatus changes a delay time of the DQS signal, reads data from the same address whenever the delay time is changed, compares the read data with the specific value, and sets in the read parameter register as an appropriate delay time an intermediate value of a range of delay time for which the comparison resulted in a match (Japanese Patent Application Publication (KOKAI) No. 2003-99321).

However, in the conventional technology for optimizing the timing to receive the DQ signal, it is not possible to infallibly receive the data from the DQ signal superimposed with the data, at timings corresponding to the rise edge and the fall edge of the DQS signal. Due to driver characteristics, a load capacity of the DDR-SDRAM, and existence or non-existence of a termination resistor, waveforms of the DQS signal and the DQ signal at the rise edge are different from those at the fall edge. Thus, a timing margin for receiving the DQ signal at the rise edge is different from that at the fall edge. Accordingly, even if the memory control apparatus sets an optimal reception timing corresponding to the rise edge of the DQS signal in the read parameter register, the reception timing corresponding to the fall edge of the DQS signal is not necessarily optimally set, and it is not possible to infallibly receive the data from the DQ signal at the timing of the fall edge of the DQS signal. The same thing can be said for a case in which an optimal reception timing corresponding to the fall edge of the DQS signal is set in the read parameter register.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view of the entire configuration of a memory optimization setting system according to a first embodiment of the invention;

FIG. 2 is an exemplary functional block diagram of the configuration of a memory control apparatus in the first embodiment;

FIG. 3 is an exemplary view of the configuration of a receiver circuit in the first embodiment;

FIG. 4 is an exemplary view of a data structure of a read parameter register in the first embodiment;

FIG. 5 is an exemplary view of a data structure of a read parameter optimization table in the first embodiment;

FIG. 6 is an exemplary view of a data structure of an optimization flag resister in the first embodiment;

FIG. 7 is an exemplary flowchart illustrating a process sequence of a memory optimization setting process in the first embodiment;

FIG. 8 is an exemplary flowchart illustrating a process sequence of an initial process in the first embodiment;

FIG. 9 is an exemplary flowchart illustrating a process sequence of a rise lower limit delay value determining process in the first embodiment;

FIG. 10 is an exemplary flowchart illustrating a process sequence of a rise upper limit delay value determining process in the first embodiment;

FIG. 11 is an exemplary flowchart illustrating a process sequence of a fall lower limit delay value determining process in the first embodiment;

FIG. 12 is an exemplary flowchart illustrating a process sequence of a fall upper limit delay value determining process in the first embodiment;

FIG. 13 is an exemplary flowchart illustrating a process sequence of an optimal delay value setting process in the first embodiment;

FIG. 14 is an exemplary flowchart illustrating a process sequence of a completing process in the first embodiment;

FIG. 15 is an exemplary functional block diagram of the configuration of a memory control apparatus according to a second embodiment of the invention;

FIG. 16 is an exemplary view of a data structure of a read parameter optimization table in the second embodiment;

FIG. 17 is an exemplary view of a data structure of an optimization flag resister in the second embodiment;

FIG. 18 is an exemplary flowchart illustrating a process sequence of a memory optimization setting process in the second embodiment;

FIG. 19 is an exemplary functional block diagram of the configuration of a memory control apparatus according to a third embodiment of the invention;

FIG. 20 is an exemplary view of a data structure of a retry table in the third embodiment;

FIG. 21A is an exemplary flowchart illustrating a process sequence of a memory optimization setting process in the third embodiment;

FIG. 21B is an exemplary flowchart illustrating a process sequence of a memory optimization setting process in the third embodiment;

FIG. 21C is an exemplary flowchart illustrating a process sequence of a memory optimization setting process in the third embodiment;

FIG. 21D is an exemplary flowchart illustrating a process sequence of a memory optimization setting process in the third embodiment;

FIG. 22 is an exemplary view of the entire configuration of a memory optimization setting system according to the related art; and

FIG. 23 is an exemplary view of an appropriate delay of a DQS signal.

### DETAILED DESCRIPTION

Various embodiments according to the invention will be described hereinafter with reference to the accompanying drawings. In general, according to one embodiment of the invention, a memory control apparatus, comprises: a generating module configured to delay a clock signal having a rise portion and a fall portion that appear in a constant cycle and to generate a plurality of delay clock signals having delay times different from each other; an extracting module configured to extract, from a data signal including known reference data, data of a portion corresponding to the rise or fall portion of each delay clock signal generated by the generating module; a first determining module configured to determine whether each data extracted by the extracting module coincides with the reference data; and a second determining module configured to determine, from the delay times of the delay clock signals corresponding to the data that have been determined by the first determining module to coincide, a range of the delay time with respect to the rise portion of the clock signal and a range of the delay time with respect to the fall portion of the clock signal.

According to another embodiment of the invention, a computer program product for memory optimization has a computer readable medium including programmed instructions, wherein the instructions, when executed by a computer, cause the computer to perform: generating including delaying a clock signal having a rise portion and a fall portion that appear in a constant cycle and generating a plurality of delay clock signals having delay times different from each other; extracting, from a data signal including known reference data, data of a portion corresponding to the rise or fall portion of each delay clock signal generated; first determining instruction of determining whether each data extracted coincides with the reference data; and second determining instruction of determining, from the delay times of the delay clock signals corresponding to the data that have been determined in the first determining instruction to coincide, a range of the delay time with respect to the rise portion of the clock signal and a range of the delay time with respect to the fall portion of the clock signal.

According to still another embodiment of the invention, a memory optimization method comprises: generating including delaying a clock signal having a rise portion and a fall portion that appear in a constant cycle and generating a plurality of delay clock signals having delay times different from each other; extracting, from a data signal including known reference data, data of a portion corresponding to the rise or fall portion of each delay clock signal generated; first determining of determining whether each data extracted coincides with the reference data; and second determining of determining, from the delay times of the delay clock signals corresponding to the data that have been determined in the first determining to coincide, a range of the delay time with respect to the rise portion of the clock signal and a range of the delay time with respect to the fall portion of the clock signal.

A memory control apparatus according to the first embodiment changes a delay time of a DQS signal, extracts data from a DQ signal synchronized with the DQS signal, determines upper and lower limits of a delay time when the extracted data is not corrupted for each of a rise edge and a fall edge of the DQS signal, and sets a delay time when extraction timing of data from the DQ signal is optimized, for each edge. Hereinafter, a process that is executed by the memory control apparatus according to the first embodiment is assumed as a “memory optimization setting process”.

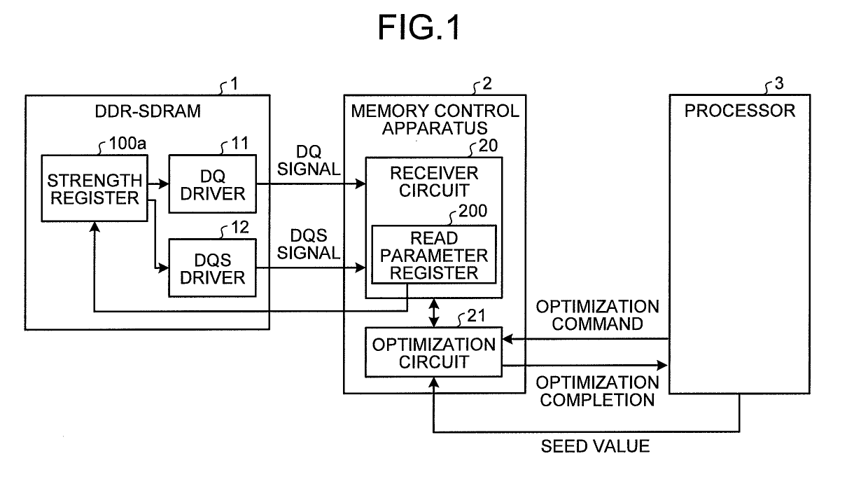

First, an example of the entire configuration of a memory optimization setting system that comprises the memory control apparatus according to the first embodiment will be described with reference to FIG. 1. As illustrated in FIG. 1, the memory optimization setting system comprises a DDR-SDRAM 1, a memory control apparatus 2, and a processor 3.

If the DDR-SDRAM 1 receives a data read command from the memory control apparatus 2, the DDR-SDRAM 1 superimposes data corresponding to an address comprised in the data read command to a DQ signal, and outputs the DQ signal to the memory control apparatus 2 through a DQ driver 11. At this time, the DDR-SDRAM 1 outputs a DQS signal indicating timing of when the memory control apparatus 2 extracts data from the DQ signal to the memory control apparatus 2 through a DQS driver 12. In the DDR-SDRAM 1, arbitrary data is stored in a specific address in advance.

A strength register 100a holds a drive strength value that indicates the strength of amplitude of a DQS signal and a DQ signal. If the drive strength value is large, the strength of the DQS signal and the DQ signal increases. If the drive strength value is small, the strength of the DQS signal and the DQ signal decreases. Accordingly, if the drive strength value decreases and the strength of the DQS signal and the DQ signal decreases, a signal waveform cannot be surely captured. Therefore, it is preferable that an optimum value be held in the drive strength value. In the strength resister 100a, the same value as the drive strength value that is set to a read parameter register 200 provided in the memory control apparatus 2 is held by a receiver circuit 20 to be described in detail below.

The memory control apparatus 2 comprises the receiver circuit 20 and an optimization circuit 21. If the receiver circuit 20 receives a DQS signal from the DDR-SDRAM 1, the receiver circuit 20 generates two DQS signals that are obtained by delaying the DQS signal by delay times of a rise edge and a fall edge set to the read parameter register 200. If the receiver circuit 20 receives a data read command from the optimization circuit 21, the receiver circuit 20 outputs the data read command to the DDR-SDRAM 1. In addition, the receiver circuit 20 extracts data of a portion corresponding to a rise edge of the DQS signal generated by delaying the rise edge, from the DQ signal, and outputs the extracted data to the optimization circuit 21. The receiver circuit 20 extracts data of a portion corresponding to a fall edge of the DQS signal generated by delaying the fall edge, from the DQ signal, and outputs the extracted data to the optimization circuit 21. In this case, the delay times of the rise edge and the fall edge are held in the read parameter register 200 by the optimization circuit 21 to be described in detail below.

If the optimization circuit 21 receives, from the processor 3, an optimization command urging determining of optimal timing where data is extracted from the DQ signal, the optimization circuit 21 sets a changed delay time to the read parameter register 200 in order to change the delay time of the DQS signal. The optimization circuit 21 outputs a data read command to the receiver circuit 20, and data of a portion corresponding to the rise edge of the DQS signal is extracted from the DQ signal, from the receiver circuit 20. The optimization circuit 21 determines whether the captured data coincides with reference data stored in the DDR-SDRAM 1. The optimization circuit 21 changes the delay time, determines whether data of a portion corresponding to the rise edge of the DQS signal extracted from the DQ signal coincides with the reference data, whenever the delay time is changed, determines upper and lower limits of the delay time of when the extracted data coincides with the reference data, and determines an optimal value of the delay time. With respect to the fall edge of the DQS signal, similarly, the optimization circuit 21 determines upper and lower limits of the delay time and determines an optimal value of the delay time. The optimization circuit 21 sets the optimal value of the delay time determined for each of the rise edge and the fall edge of the DQS signal to the read parameter register 200, and outputs an optimization completion message indicating that optimization has been completed to the processor 3. The optimal value of the delay time for each of the rise edge and the fall edge of the DQS signal maybe an intermediate value of the determined upper and lower limits of the delay time, but is not limited thereto.

The processor 3 is an upper apparatus of the memory control apparatus 2, and outputs an optimization command to the memory control apparatus 2 and receives the optimization completion message from the memory control apparatus 2. Before outputting the optimization command to the memory control apparatus 2, the processor 3 holds a seed value indicating a default of the delay time in the optimization circuit 21.

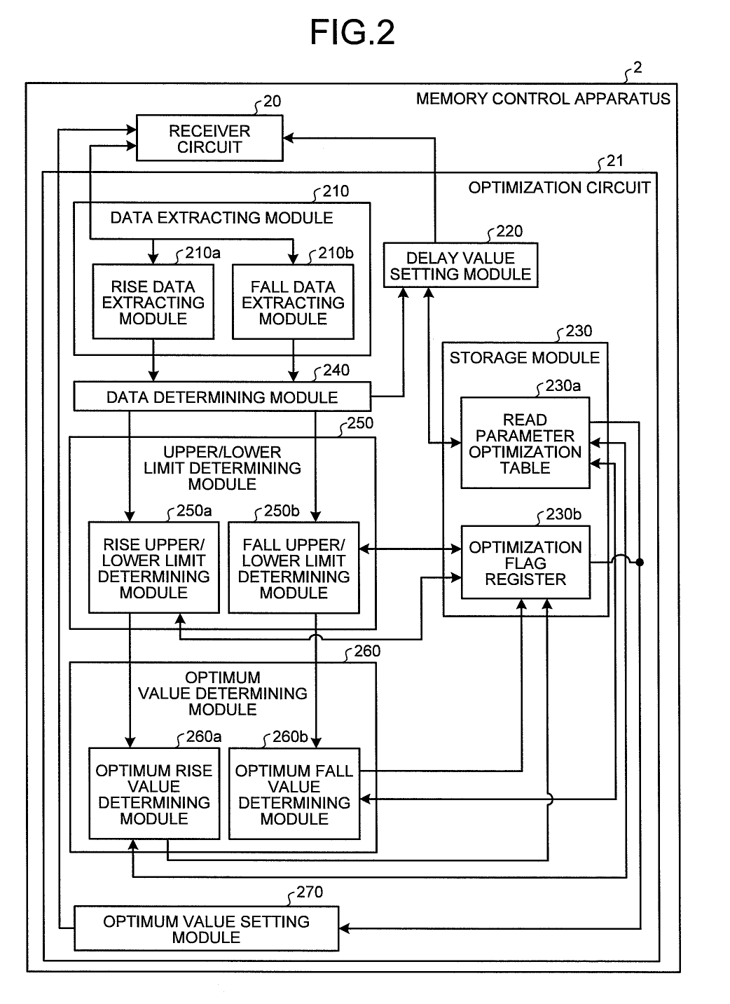

Next, the memory control apparatus according to the first embodiment will be described with reference to FIG. 2. FIG. 2 is a functional block diagram of the configuration of the memory control apparatus in the first embodiment. As illustrated in FIG. 2, the memory control apparatus 2 comprises the receiver circuit 20 and the optimization circuit 21.

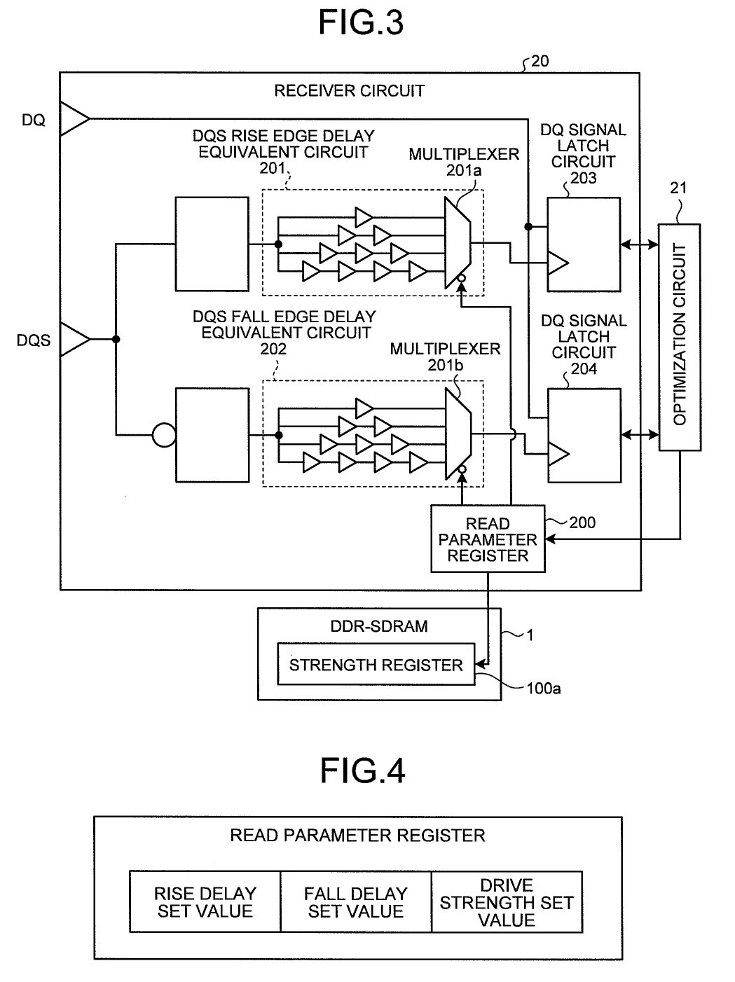

The receiver circuit 20 delays the DQS signal according to the delay time that is held in the read parameter register. In this case, the configuration of the receiver circuit will be described with reference to FIG. 3. As illustrated in FIG. 3, the receiver circuit 20 comprises the read parameter register 200, a DQS rise edge delay equivalent circuit 201, a DQS fall edge delay equivalent circuit 202, and DQ signal latch circuits 203 and 204.

The read parameter register 200 holds a parameter with respect to the DQS signal that passes through the DQS rise edge delay equivalent circuit 201 and the DQS fall edge delay equivalent circuit 202. In this case, a data structure of the read parameter register 200 will be described with reference to FIG. 4. As illustrated in FIG. 4, the read parameter register 200 holds a rise delay set value, a fall delay set value, and a drive strength set value. The rise delay set value is a time by which the rise edge of the DQS signal is delayed, and is set to a multiplexer 201a of the DQS rise edge delay equivalent circuit 201. The fall delay set value is a time by which the fall edge of the DQS signal is delayed, and is set to a multiplexer 201b of the DQS fall edge delay equivalent circuit 202. The drive strength set value is a value indicating the strength of amplitude of the DQS signal and the DQ signal, and is set to the strength register 100a of the DDR-SDRAM 1.

The DQS rise edge delay equivalent circuit 201 delays the DQS signal according to the rise delay value indicating a delay time of the rise edge of the DQS signal, which is set to the DQS rise delay set value of the read parameter register 200 from a delay value setting module 220.

The DQS fall edge delay equivalent circuit 202 delays the DQS signal according to the fall delay value indicating a delay time of the fall edge of the DQS signal, which is set to the DQS fall delay set value of the read parameter register 200 from the delay value setting module 220.

If the DQ signal latch circuit 203 receives a data read command from a rise data extracting module 210a, the DQ signal latch circuit 203 receives the DQS signal that is delayed by the DQS rise edge delay equivalent circuit 201, and extracts data of a portion corresponding to the rise edge of the DQS signal from the DQ signal. In addition, the DQ signal latch circuit 203 outputs the extracted data to the rise data extracting module 210a.

If the DQ signal latch circuit 204 receives a data read command from a fall data extracting module 210b, the DQ signal latch circuit 204 receives the DQS signal that is delayed by the DQS fall edge delay equivalent circuit 202, and extracts data of a portion corresponding to the fall edge of the DQS signal from the DQ signal. In addition, the DQ signal latch circuit 204 outputs the extracted data to the fall data extracting module 210b.

Referring back to FIG. 2, the optimization circuit 21 comprises a data extracting module 210, the delay value setting module 220, a storage module 230, a data determining module 240, an upper/lower limit determining module 250, an optimum value determining module 260, and an optimum value setting module 270.

The data extracting module 210 comprises the rise data extracting module 210a and the fall data extracting module 210b. If the rise data extracting module 210a outputs a data read command to the DQ signal latch circuit 203 in order to read arbitrary data stored in a specific address of the DDR-SDRAM 1 in advance, the rise data extracting module 210a receives the data that is extracted from the DQ signal at a time corresponding to the rise edge of the DQS signal by the DQ signal latch circuit 203. In addition, the rise data extracting module 210a outputs the extracted data to the data determining module 240.

If the fall data extracting module 210b outputs a data read command to the DQ signal latch circuit 204, the fall data extracting module 210b receives the data that is extracted from the DQ signal at a time corresponding to the fall edge of the DQS signal by the DQ signal latch circuit 204. In addition, the fall data extracting module 210b outputs the extracted data to the data determining module 240.

If the delay value setting module 220 acquires an optimization command from the processor 3, the delay value setting module 220 stores arbitrary data in a specific address of the DDR-SDRAM 1. The delay value setting module 220 reads a drive strength value and a rise lower limit delay value indicating a lower limit of the delay time of the rise edge of the DQS signal that are held in a read parameter optimization table 230a, holds the drive strength value and the rise lower limit delay value in the drive strength set value and the rise delay set value of the read parameter register 200, and sets the drive strength value to the strength register 100a of the DDR-SDRAM 1 and the delay value to the DQS rise edge delay equivalent circuit 201 of the receiver circuit 20. If the delay value setting module 220 receives a message indicating that data is normal or abnormal from the data determining module 240, by a state of a determination sequence of the rise delay lower limit, the delay value setting module 220 subtracts the rise lower limit delay value of the read parameter optimization table 230a by 1 and holds the rise lower limit delay value, adds the rise lower limit delay value by 1 and holds the rise lower limit delay value, adds the rise upper limit delay value by 1 and holds the rise upper limit delay value, subtracts the rise lower limit delay value by 1 and holds the rise lower limit delay value, and holds the delay value in the rise delay set value of the read parameter register 200. Next, the delay value setting module 220 adds the rise upper limit delay value indicating the upper limit of the delay time of the rise edge of the DQS signal held in the read parameter optimization table 230a by 1, holds the rise upper limit delay value in the rise delay set value of the read parameter register 200, and sets the delay value to the DQS rise edge delay equivalent circuit 201. If the delay value setting module 220 receives a message indicating that data is normal from the data determining module 240, the delay value setting module 220 adds the rise upper limit delay value by 1, holds the rise upper limit delay value in the rise delay set value of the read parameter register 200, and holds a delay value that is obtained by adding the rise upper limit delay value of the read parameter optimization table 230a by 1.

The delay value setting module 220 holds the fall lower limit delay value, which is held in the read parameter optimization table 230a, in the fall delay set value of the read parameter register 200, and sets the delay value to the DQS fall edge delay equivalent circuit 202 of the receiver circuit 20. If the delay value setting module 220 receives a message indicating that data is normal or abnormal from the data determining module 240, by a state of a determination sequence of the fall delay lower limit, the delay value setting module 220 subtracts the fall lower limit delay value of the read parameter optimization table 230a by 1 and holds the fall lower limit delay value, adds the fall lower limit delay value by 1 and holds the fall lower limit delay value, adds the fall upper limit delay value by 1 and holds the fall upper limit delay value, subtracts the fall lower limit delay value by 1 and holds the fall lower limit delay value, and holds the delay value in the fall delay set value of the read parameter register 200. Next, the delay value setting module 220 adds the fall upper limit delay value held in the read parameter optimization table 230a by 1, holds the fall upper limit delay value in the fall delay set value of the read parameter register 200, and sets the delay value to the DQS fall edge delay equivalent circuit 202. If the delay value setting module 220 receives a message indicating that data is normal from the data determining module 240, the delay value setting module 220 adds the fall upper limit delay value by 1, holds the delay value in the fall delay set value of the read parameter register 200, and holds a delay value that is obtained by adding 1 to the fall upper limit delay value of the read parameter optimization table 230a.

If the data determining module 240 receives the data from the rise data extracting module 210a, the data determining module 240 determines whether the extracted data coincides with the reference data written to the DDR-SDRAM 1. When the extracted data coincides with the reference data, the data determining module 240 outputs a message indicating that the data is normal to the delay value setting module 220 and a rise upper/lower limit determining module 250a. When the extracted data does not coincide with the reference data, the data determining module 240 outputs a message indicating that the data is abnormal to the delay value setting module 220 and the rise upper/lower limit determining module 250a.

The storage module 230 comprises the read parameter optimization table 230a and an optimization flag register 230b.

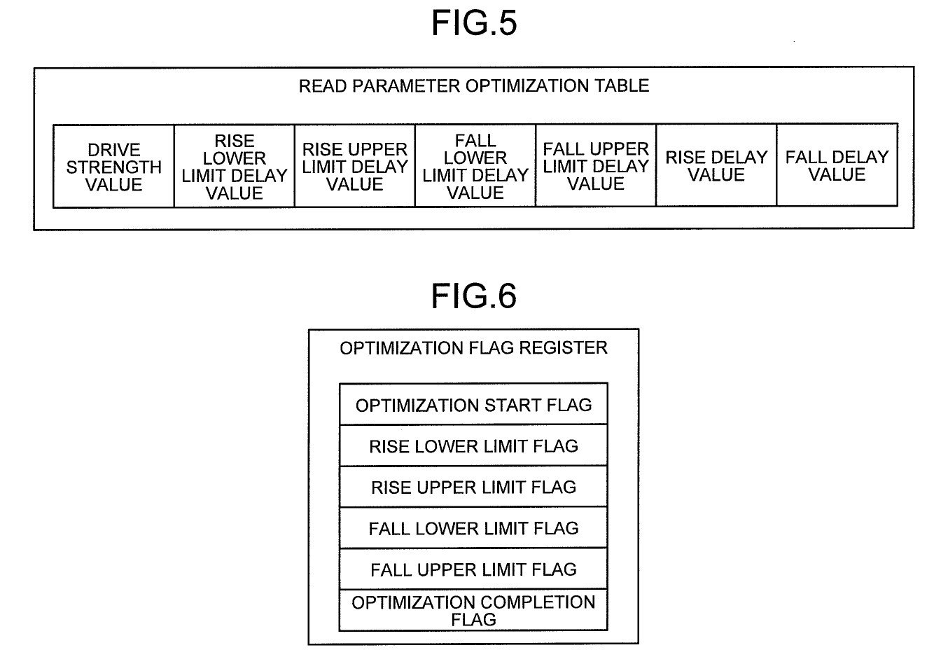

The read parameter optimization table 230a holds various parameters that are used during the execution of a memory optimization setting process. In this case, a data structure of the read parameter optimization table 230a according to the first embodiment will be described with reference to FIG. 5. As illustrated in FIG. 5, the read parameter optimization table 230a holds a drive strength value indicating the strength of a signal, a rise lower limit delay value, a rise upper limit delay value, a fall lower limit delay value, fall upper limit delay value, a rise delay value, and a fall delay value. The rise lower limit delay value and the rise upper limit delay value are upper and lower limits of the time by which the DQS signal is delayed in order to correctly extract the data from the DQ signal at the time corresponding to the rise edge of the DQS signal, and are in a range of 0 to 9 (unit:clock). The fall lower limit delay value and the fall upper limit delay value are upper and lower limits of the time by which the DQS signal is delayed in order to correctly extract the data from the DQ signal at the time corresponding to the fall edge of the DQS signal, and are in a range of 0 to 9 (unit:clock). The rise delay value is an optimal value of the delay time of the DQS signal to correctly extract the data from the DQ signal at the time corresponding to the rise edge of the DQS signal, and is in a range of 0 to 9 (unit:clock). The fall delay value is an optimal value of the delay time of the DQS signal to correctly extract the data from the DQ signal at the time corresponding to the fall edge of the DQS signal, and is in a range of 0 to 9 (unit:clock). Before a memory optimization setting process starts, the seed value that is held in the delay value is 5 as a common value (unit:clock).

The optimization flag register 230b holds a progress situation of the memory optimization setting process. In this case, a data structure of the optimization flag register 230b according to the first embodiment will be described with reference to FIG. 6. As illustrated in FIG. 6, the optimization flag register 230b holds an optimization start flag, a rise lower limit flag, a rise upper limit flag, a fall lower limit flag, a fall upper limit flag, and an optimization completion flag. The optimization start flag indicates whether a memory optimization setting process starts. The rise lower limit flag and the rise upper limit flag indicate a determination/non-determination of upper and lower limits of the time by which the rise edge of the DQS signal is delayed. The fall lower limit flag and the fall upper limit flag indicate a determination/non-determination of upper and lower limits of the time by which the fall edge of the DQS signal is delayed. The optimization completion flag indicates a completion/non-completion of the memory optimization setting process.

If the data determining module 240 receives data from the fall data extracting module 210b, the data determining module 240 determines whether the acquired data coincides with the reference data written to the DDR-SDRAM 1. When the acquired data coincides with the reference data, the data determining module 240 outputs a message indicating that the data is normal to the delay value setting module 220 and a fall upper/lower limit determining module 250b. When the extracted data does not coincide with the reference data, the data determining module 240 outputs a message indicating that the data is abnormal to the delay value setting module 220 and the fall upper/lower limit determining module 250b.

The upper/lower limit determining module 250 comprises the rise upper/lower limit determining module 250a and the fall upper/lower limit determining module 250b. If the rise upper/lower limit determining module 250a receives the message indicating that the data is normal and the message indicating that the data is abnormal from the data determining module 240 and recognizes a rise lower limit delay or upper limit delay where data can be normally extracted, the rise upper/lower limit determining module 250a sets ON (for example, “1”) indicating a completion to a rise lower limit flag or upper limit flag of the optimization flag register 230b. In addition, when both of the rise lower limit flag and the rise upper limit flag of the optimization flag register 230b become ON, the rise upper/lower limit determining module 250a outputs a message indicating that the upper and lower limits of the rise delay value have been determined to a optimum rise value determining module 260a. The memory optimization setting process determines the delay value in the order of the lower limit and the upper limit.

If the fall upper/lower limit determining module 250b receives the message indicating that the data is normal and the message indicating that the data is abnormal from the data determining module 240 and recognizes a fall lower limit or upper limit delay where data can be normally extracted, the fall upper/lower limit determining module 250b sets ON (for example, “1”) indicating a completion to a fall lower limit flag or upper limit flag of the optimization flag register 230b. In addition, when both of the fall lower limit flag and the fall upper limit flag of the optimization flag register 230b become ON, the fall upper/lower limit determining module 250b outputs a message indicating that the upper and lower limits of the fall delay value have been determined to a optimum fall value determining module 260b.

The optimum value determining module 260 comprises the optimum rise value determining module 260a and the optimum fall value determining module 260b. If the optimum rise value determining module 260a receives a message indicating that the upper and lower limits of the rise delay value have been determined from the rise upper/lower limit determining module 250a, the optimum rise value determining module 260a reads the rise lower limit delay value and the rise upper limit delay value that are held in the read parameter optimization table 230a, and calculates an intermediate value of the rise lower limit delay value and the rise upper limit delay value. In addition, the optimum rise value determining module 260a holds the intermediate value in the rise delay value of the read parameter optimization table 230a.

If the optimum fall value determining module 260b receives a message indicating that the upper and lower limits of the fall delay value have been determined from the fall upper/lower limit determining module 250b, the optimum fall value determining module 260b reads the fall lower limit delay value and the fall upper limit delay value that are held in the read parameter optimization table 230a, and calculates an intermediate value of the fall lower limit delay value and the fall upper limit delay value. The optimum fall value determining module 260b holds the intermediate value in the fall delay value of the read parameter optimization table 230a, and sets ON (for example, “1”) indicating that optimization has been completed to the optimization completion flag of the optimization flag register 230b.

When ON indicating that optimization has been completed is set to the optimization completion flag of the optimization flag register 230b, the optimum value setting module 270 reads the rise delay value and the fall delay value that are held in the read parameter optimization table 230a, holds the rise delay value in the rise delay set value of the read parameter register 200, holds the fall delay value in the fall delay set value of the read parameter register 200, and sets the rise delay value and the fall delay value to the DQS rise edge delay equivalent circuit 201 and the DQS fall edge delay equivalent circuit 202, respectively. The optimum value setting module 270 outputs an optimization completion message to the processor 3.

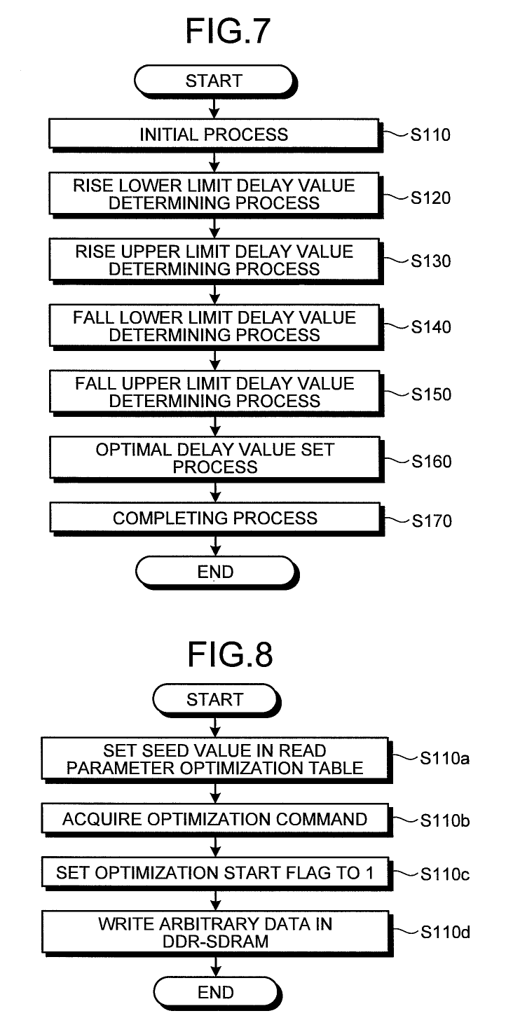

Next, a process sequence of the memory optimization setting process according to the first embodiment will be described with reference to FIGS. 7 to 14. In FIG. 7, the process sequence of the optimization setting process according to the first embodiment will be described. In FIGS. 8 to 14, a process sequence of each process of the memory optimization setting process will be described.

FIG. 7 is a flowchart illustrating a process sequence of a memory optimization setting process in the first embodiment.

First, the optimization circuit 21 executes an initial process (S110). Next, the optimization circuit 21 executes a process of determining a lower limit delay value and an upper limit delay value of a rise edge of the DQS signal (S120 and S130). Next, the optimization circuit 21 executes a determining process of a lower limit delay value and an upper limit delay value of a fall edge of the DQS signal (S140 and S150). Next, the optimization circuit 21 executes a process of setting an optimal value of the delay value of the rise edge and an optimal value of the delay value of the fall edge to the read parameter register 200 (S160). Next, the optimization circuit 21 executes a completing process (S170).

FIG. 8 is a flowchart illustrating a process sequence of an initial process of the memory optimization setting process in the first embodiment.

A seed value is held in the read parameter optimization table 230a by the processor 3 (S110a). Next, the delay value setting module 220 receives an optimization command from the processor 3 (S110b), and sets an optimization start flag of the optimization flag register 230b to “1” (S110c). Next, the delay value setting module 220 writes predetermined data (reference data) in a specific address of the DDR-SDRAM 1 (S110d).

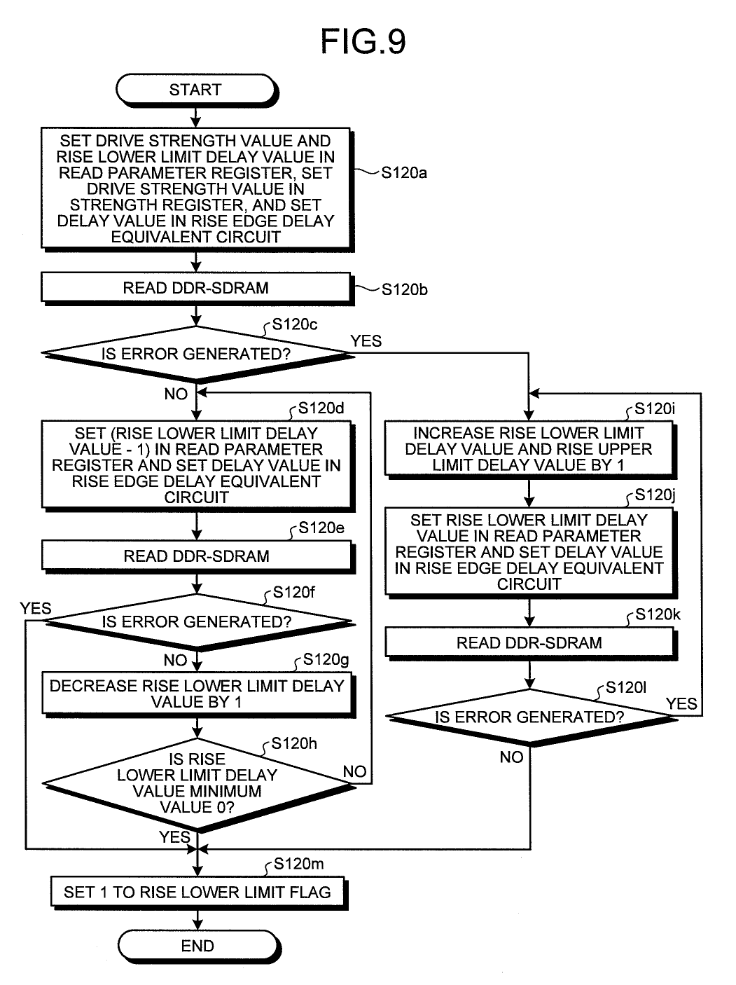

FIG. 9 is a flowchart illustrating a process sequence of a rise lower limit delay value determining process in the memory optimization setting process in the first embodiment.

After the initial process is executed, the delay value setting module 220 sets the drive strength value and the rise lower limit delay value held in a read parameter optimization table 220a to the drive strength set value and the rise delay set value of the read parameter register 200, and sets the drive strength set value to the strength register 100a of the DDR-SDRAM 1 and the rise delay set value to the DQS rise edge delay equivalent circuit 201 (S120a).

In order to read the data stored in the specific address of the DDR-SDRAM 1, the rise data extracting module 210a outputs a data read command comprising the specific address to the DQ signal latch circuit 203, and extracts data of a portion corresponding to the rise edge from the DQ signal where the data is superimposed (S120b). Next, the data determining module 240 determines whether the acquired data coincides with the reference data (S120c).

When it is determined that the extracted data coincides with the reference data (No at S120c), the delay value setting module 220 sets a value, which is obtained by subtracting the rise lower limit delay value held in the read parameter optimization table 220a by a predetermined value (for example, 1 clock), to the delay set value of the read parameter register 200, and sets the value to the DQS rise edge delay equivalent circuit 201 (S120d).

Next, the rise data extracting module 210a extracts data from the specific address of the DDR-SDRAM 1 again (S120e). In addition, the data determining module 240 determines whether the extracted data coincides with the reference data (S120f).

When it is determined that the acquired data coincides with the reference data (No at S120f), the delay value setting module 220 subtracts the rise lower limit delay value held in the read parameter optimization table 220a by a predetermined value (for example, 1 clock) (S120g), and determines whether the rise lower limit delay value is a minimum value (for example, “0”) (S120h). At this time, when the rise lower limit delay value is not the minimum value (for example, “0”) (No at S120h), the delay value setting module 220 repeats a process of determining the rise lower limit delay value.

Meanwhile, when it is determined that the extracted data does not coincide with the reference data (Yes at S120c), the delay value setting module 220 adds each of the rise lower limit delay value and the rise upper limit delay value of the read parameter optimization table 220a by the predetermined value (for example, 1 clock) (S120i), holds the added values in the read parameter optimization table 230a, sets the fall lower limit delay value to the rise delay set value of the read parameter register 200, and sets the fall lower limit delay value to the DQS rise edge delay equivalent circuit 201 (S120j). The reason why the rise upper/lower limit delay value is adjusted and added by the predetermined value is because the lower limit of the rise edge is not determined. Next, the rise data extracting module 210a extracts data from the specific address of the DDR-SDRAM 1 again S120k). The data determining module 240 determines whether the extracted data coincides with the reference data (S120l). When it is determined that the extracted data does not coincide with the reference data (Yes at S120l), the delay value setting module 220 repeats a process of determining the rise lower limit delay value.

Meanwhile, when the data extracted after the rise upper and lower limit delay values are adjusted coincides with the reference data (No at S120l), when the rise lower limit delay value is the minimum value (for example, 0) (Yes at S120h) or when the data extracted without adjusting the rise lower and upper limit delay values does not coincide with the reference data (Yes at S120f), the rise upper/lower limit determining module 250a sets “1” to the rise lower limit flag of the optimization flag register 230b, because the rise lower limit value is determined (S120m).

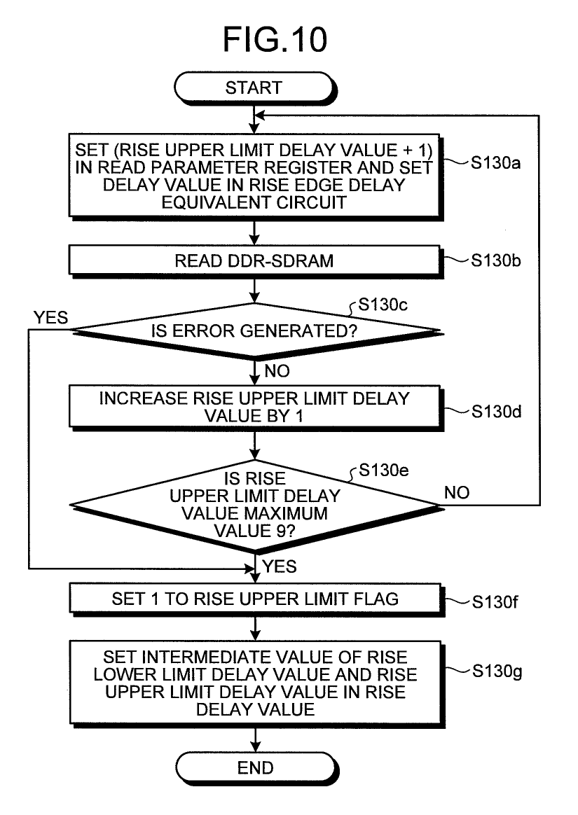

FIG. 10 is a flowchart illustrating a process sequence of a rise upper limit delay value determining process in the memory optimization setting process in the first embodiment.

After the rise lower limit delay value determining process is executed, the delay value setting module 220 sets a value, which is obtained by adding the rise upper limit delay value held in the read parameter optimization table 220a by the predetermined value (for example, 1 clock), to the rise delay set value of the read parameter register 200, and sets the value to the DQS rise edge delay equivalent circuit 201 (S130a).

Next, the rise data extracting module 210a extracts data from the specific address of the DDR-SDRAM 1 (S130b). In addition, the data determining module 240 determines whether the extracted data coincides with the reference data (S130c).

When it is determined that the extracted data coincides with the reference data (No at S130c), the delay value setting module 220 adds the rise upper limit delay value held in the read parameter optimization table 220a by the predetermined value (for example, 1 clock) (S130d), and determines whether the rise upper limit delay value is a maximum value (for example, 9 clocks) (S130e). At this time, when the rise upper limit delay value is not the maximum value (for example, 9 clocks) (No at S130e), the delay value setting module 220 repeats a process of determining the rise upper limit delay value.

Meanwhile, when the rise upper limit delay value is the maximum value (for example, 9 clocks) (Yes at S130e) or the extracted data is not matched with the reference data (Yes at S130c), the rise upper/lower limit determining module 250a sets 1 to the rise upper limit flag of the optimization flag register 230b, because the rise upper limit is determined (S130f).

The optimum rise value determining module 260a sets an intermediate value of the rise lower limit delay value and the rise upper limit delay value held in the read parameter optimization table 230a to the rise delay value of the read parameter optimization table 230a (S130g).

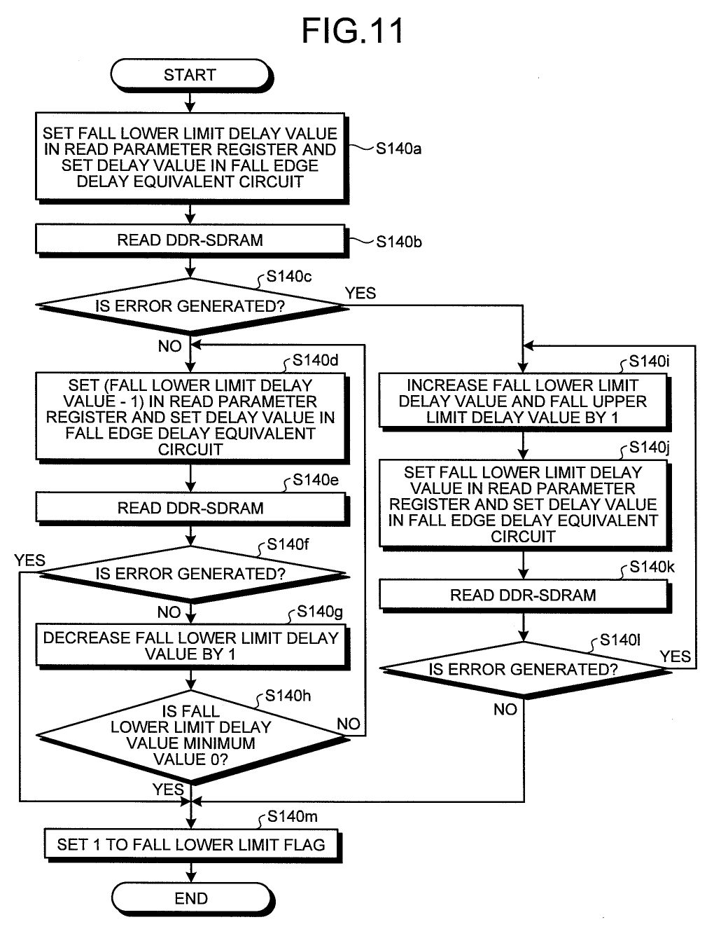

FIG. 11 is a flowchart illustrating a process sequence of a fall lower limit delay value determining process in the memory optimization setting process in the first embodiment. In FIG. 11, since the process is the same as the rise lower limit delay value determining process (refer to FIG. 9), the repetitive description is omitted. However, in FIG. 11, the rise lower limit delay value, the rise upper limit delay value, and the rise lower limit flag that are used in FIG. 9 are replaced by the fall lower limit delay value, the fall upper limit delay value, and the fall lower limit flag, respectively.

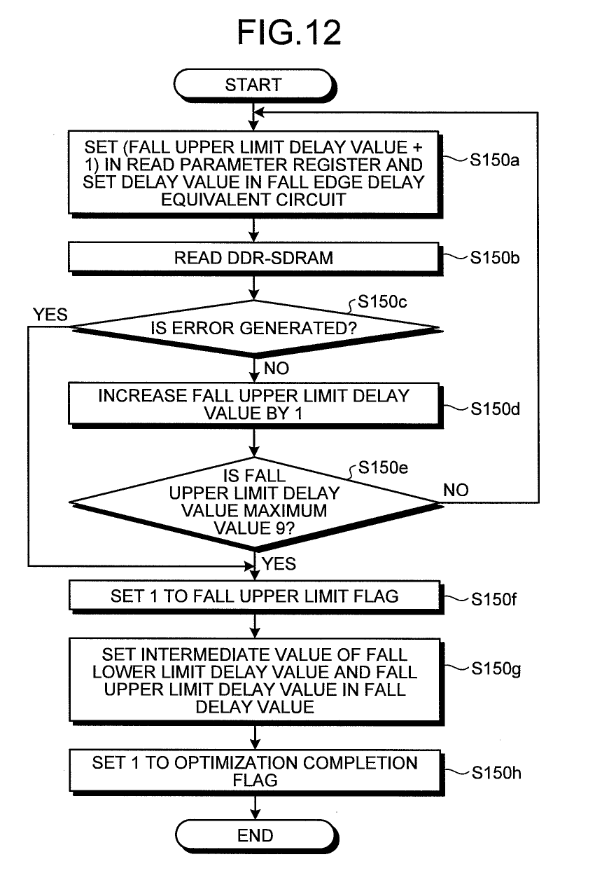

FIG. 12 is a flowchart illustrating a process sequence of a fall upper limit delay value determining process in the memory optimization setting process according to the first embodiment. In FIG. 12, since the process is almost the same as the rise upper limit delay value determining process (refer to FIG. 10), the description of the same process is omitted. However, in FIG. 12, the rise upper limit delay value and the rise upper limit flag that are used in FIG. 10 are replaced by the fall upper limit delay value and the fall upper limit flag, respectively.

When the fall upper limit delay value determining process is completed, the optimum fall value determining module 260b sets 1 to the optimization completion flag of the optimization flag register 230b (S150h).

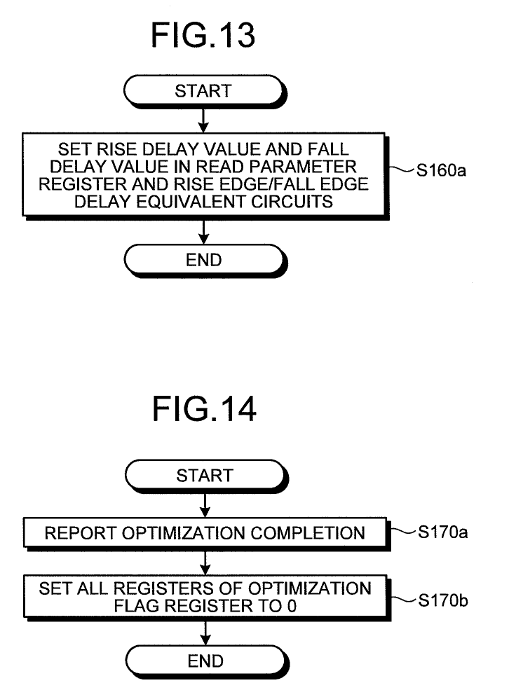

FIG. 13 is a flowchart illustrating a process sequence of an optimal delay value setting process in the memory optimization setting process according to the first embodiment.

When 1 is set to the optimization completion flag of the optimization flag register 230b, the optimum value setting module 270 sets the rise delay value held in the read parameter optimization table 230a to the rise delay set value of the read parameter register 200, and sets the rise delay value to the DQS rise edge delay equivalent circuit 201. The optimum value setting module 270 sets the fall delay value held in the read parameter optimization table 230a to the fall delay set value of the read parameter register 200, and sets the fall delay value to the DQS fall edge delay equivalent circuit 202 (S160a).

FIG. 14 is a flowchart illustrating a process sequence of a completing process in the memory optimization setting process according to the first embodiment.

After the optimal delay vale setting process is executed, the optimum value setting module 270 outputs an optimization completion message to the processor 3, because the memory optimization setting process is completed (S170a). The optimum value setting module 270 sets all registers of the optimization flag register to 0 (S170b).

As such, according to the first embodiment, the memory control apparatus 2 delays the DQ signals where the rise edge and the fall edge appear with the constant period and generates the delay DQS signals where the delay times are different from each other. Next, the memory control apparatus 2 extracts data of the portions corresponding to the rise edges or the fall edges of the generated delay DQS signals, from the DQ signal partially having the existing reference data. The memory control apparatus 2 determines whether the extracted data of the portion corresponding to the rise edge and the fall edge of each delay DQ signal coincides with the reference data. As the judgment result, when the data of the portion corresponding to the rise edge of any delay DQS signal coincides with the reference data, the memory control apparatus 2 determines a range of the delay time with respect to the rise portion of the DQS signal. When the data of the portion corresponding to the fall portion of any delay DQS signal coincides with the reference data, the memory control apparatus 2 determines a range of the delay time with respect to the fall portion of the DQS signal.

In this way, since the memory control apparatus 2 individually determines the time by which the DQS signal is delayed with respect to the rise edge and the fall edge of the DQS signal, even though the waveforms of the DQS signal and the DQ signal are different at the rise edge and the fall edges, the memory control apparatus 2 can determine an appropriate delay time. As a result, the memory control apparatus 2 sets the determined delay time of each of the rise edge and the fall edge of the DQS signal to the receiver circuit 20, thereby securely receiving data where a corrupted data error is not generated, from the DQ signal where the data is superimposed at the timing of the rise edge and the fall edge of the DQS signal.

Meanwhile, in the first embodiment, the drive strength indicating the strength of the waveforms of the DQS signal and the DQ signal is fixed, and the delay time of the DQS signal for each of the rise edge and the fall edge of the DQS signal is determined. However, the invention is not limited thereto, and the drive strength may be changed, the range of the delay time of the DQS signal for each of the rise edge and the fall edge of the DQS signal may be determined for each changed drive strength, and the delay time of the DQS signal for each of the rise edge and the fall edge using the drive strength where the range of the delay time is maximized may be determined.

In the second embodiment, the description is given to the case where the drive strength is changed, the range of the delay time of the DQS signal for each of the rising edge and the fall edge of the DQS signal is determined for each changed drive strength, and the delay time of the DQS signal for each of the rise edge and the fall edge using the drive strength where the range of the delay time is maximized is determined.

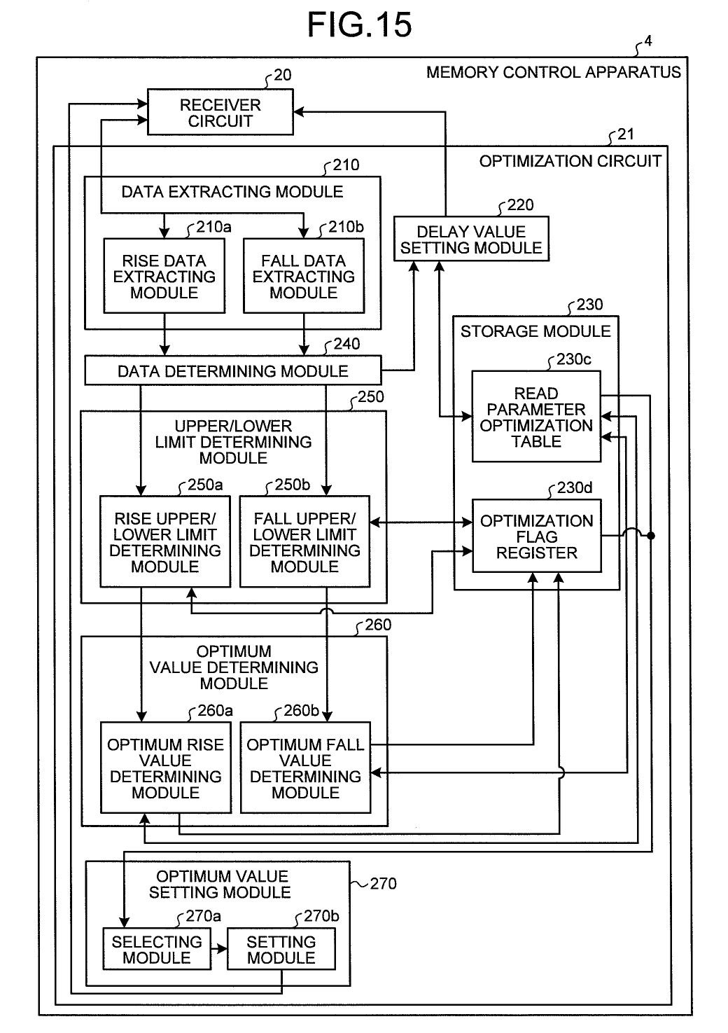

First, the configuration of a memory control apparatus according to the second embodiment will be described with reference to FIG. 15. FIG. 15 is a functional block diagram of the configuration of a memory control apparatus according to the second embodiment of the invention. As illustrated in FIG. 15, in a memory control apparatus 4 according to the second embodiment, in addition to the components of the memory control apparatus 2 (refer to FIG. 2) according to the first embodiment, a selecting module 270a and a setting module 270b are added, and a read parameter optimization table 230c and an optimization flag register 230d are changed. In FIG. 15, the same components as those in FIG. 2 are denoted by the same reference numerals and the repetitive description is omitted.

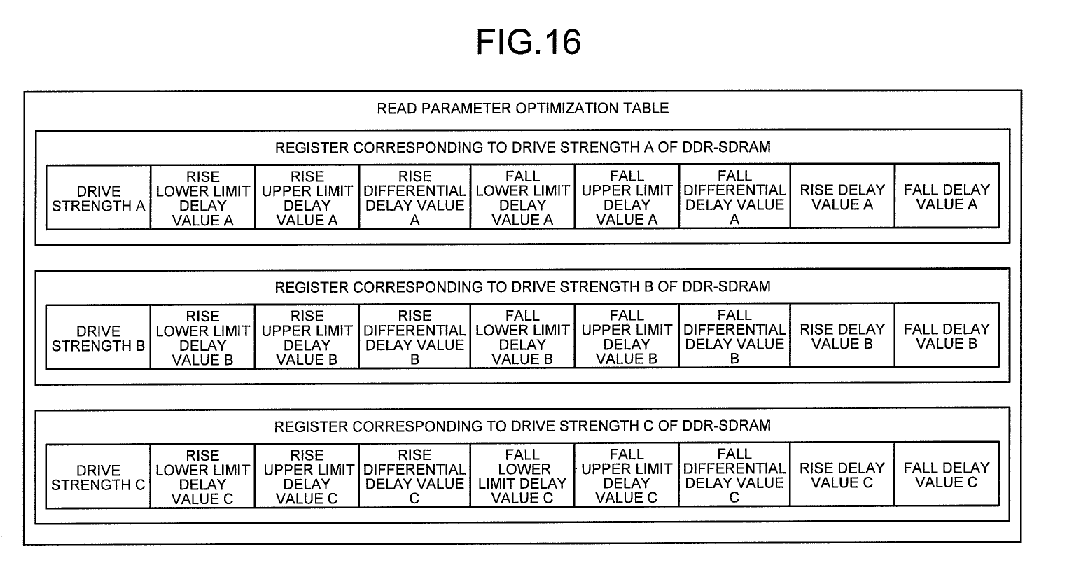

The read parameter optimization table 230c holds various parameters that are used during the execution of the memory optimization setting process, and the parameters are held for each of a plurality of different drive strengths. In this case, a data structure of the read parameter optimization table 230c according to the second embodiment will be described with reference to FIG. 16. As illustrated in FIG. 16, the read parameter optimization table 230c holds various parameters that correspond to drive strengths A, B, and C. The various parameters comprise a drive strength value, a rise lower limit delay value, a rise upper limit delay value, a rise differential delay value, a fall lower limit delay value, a fall upper limit delay value, a falling differential delay value, a rise delay value, and a fall delay value. The rise differential delay value is a difference between the rise lower limit delay value and the rise upper limit delay value. The falling differential delay value is a difference between the fall lower limit delay value and the fall upper limit delay value. The read parameter optimization table 230c holds the three kinds of drive strengths A, B, and C, but the invention is not limited thereto. For example, the read parameter optimization table 230c may hold parameters of four kinds or more.

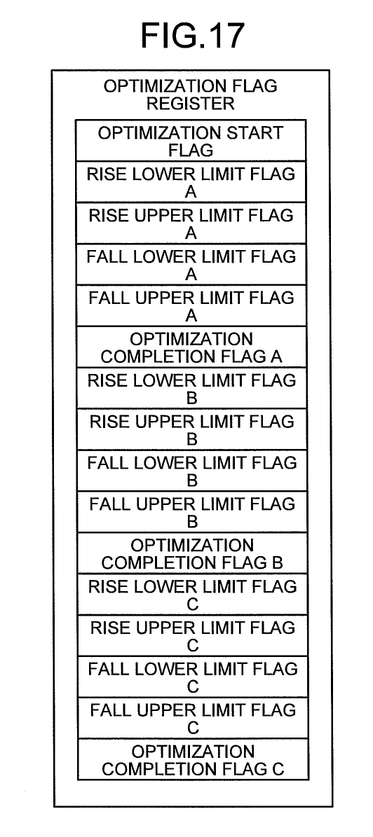

The optimization flag register 230d holds a progress situation of the memory optimization setting process, and the progress situation is held for each process executed for each of the different drive strengths. In this case, a data structure of the optimization flag register 230d according to the second embodiment will be described with reference to FIG. 17. As illustrated in FIG. 17, the optimization flag register 230d holds an optimization start flag, and a rise lower limit flag, a rise upper limit flag, a fall lower limit flag, a fall upper limit flag, and an optimization completion flag that correspond to each of the drive strengths A, B, and C.

If the delay value setting module 220 receives an optimization command from the processor 3, the delay value setting module 220 reads the drive strength value and the rise lower limit delay value corresponding to the drive strength A held in the read parameter optimization table 230c, holds the drive strength value and the rise lower limit delay value in the drive strength set value and the rise delay set value of the read parameter register 200, and sets the drive strength value to the strength register 100a of the DDR-SDRAM 1 and the delay value to the DQS rise edge delay equivalent circuit 201 of the receiver circuit 20. Next, the delay value setting module 220 reads the rise upper limit delay value held in the read parameter optimization table 230c, holds the rise upper limit delay value in the rise delay set value of the read parameter register 200, and sets the delay value to the DQS rise edge delay equivalent circuit 201 of the receiver circuit 20. Next, the delay value setting module 220 reads the fall lower limit delay value corresponding to the drive strength A held in the read parameter optimization table 230c, holds the fall lower limit delay value in the fall delay set value of the read parameter register 200, and sets the delay value to the DQS fall edge delay equivalent circuit 202 of the receiver circuit 20. Next, the delay value setting module 220 reads the fall upper limit delay value held in the read parameter optimization table 230c, holds the fall upper limit delay value in the fall delay set value of the read parameter register 200, and sets the delay value to the DQS fall edge delay equivalent circuit 202 of the receiver circuit 20. The delay value setting module 220 holds the drive strength value corresponding to the individual drive strength to the read parameter register 200 and the strength register 100a of the DDR-SDRAM 1, in the order of the drive strengths A, B, and C.

If the optimum rise value determining module 260a receives a message indicating that the upper and lower limits of the delay value have been determined from the rise upper/lower limit determining module 250a, the optimum rise value determining module 260a reads the rise lower limit delay value and the rise upper limit delay value held in the read parameter optimization table 230c, calculates an intermediate value of the rise lower limit delay value and the rise upper limit delay value, and holds the intermediate value in the rise delay value of the read parameter optimization table 230c. The optimum rise value determining module 260a calculates a difference of the rise lower limit delay value and the rise upper limit delay value read from the read parameter optimization table 230c, and holds the difference in the rise differential delay value of the read parameter optimization table 230c.

If the optimum fall value determining module 260b receives a message indicating that the upper and lower limits of the delay value have been determined from the fall upper/lower limit determining module 250b, the optimum fall value determining module 260b reads the fall lower limit delay value and the fall upper limit delay value that are held in the read parameter optimization table 230c, calculates an intermediate value of the fall lower limit delay value and the fall upper limit delay value, and holds the intermediate value in the fall delay value of the read parameter optimization table 230c. The optimum fall value determining module 260b calculates a difference of the fall lower limit delay value and the fall upper limit delay value read from the read parameter optimization table 230c, and holds the difference in the falling differential delay value of the read parameter optimization table 230c. The optimum fall value determining module 260b sets ON (for example, “1”) indicating that optimization has been completed to the optimization completion flag of the optimization flag register 230d.

The optimum value setting module 270 comprises the selecting module 270a and the setting module 270b. When ON indicating that the optimization has been completed is set to all of the optimization completion flags A, B, and C of the optimization flag register 230d, the selecting module 270a selects the drive strength indicating that the rise differential delay value (or falling differential delay value) corresponding to the drive strengths A, B, and C is a maximum value. Specifically, the selecting module 270a reads rise differential delay values A, B, and C (or falling differential delay values A, B, and C) corresponding to the drive strengths A, B, and C from the read parameter optimization table 230c. The selecting module 270a selects the drive strength corresponding to the rise differential delay value (or falling differential delay value) that is the maximum value of the read rise differential delay values. The selecting module 270a outputs the selected drive strength, the rise delay value corresponding to the selected drive strength, and the fall delay value to the setting module 270b.

If the setting module 270b acquires the drive strength, the rise delay value, and the fall delay value from the selecting module 270a, the setting module 270b sets the drive strength, the rise delay value, and the fall delay value to the drive strength set value, the rise delay set value, and the fall delay set value of the read parameter register 200, respectively, and sets the drive strength, the rise delay value, and the fall delay value to the strength register 100a of the DDR-SDRAM 1, the DQS rise edge delay equivalent circuit 201, and the DQS fall edge delay equivalent circuit 202. The optimum value setting module 270 outputs an optimization completion message to the processor 3.

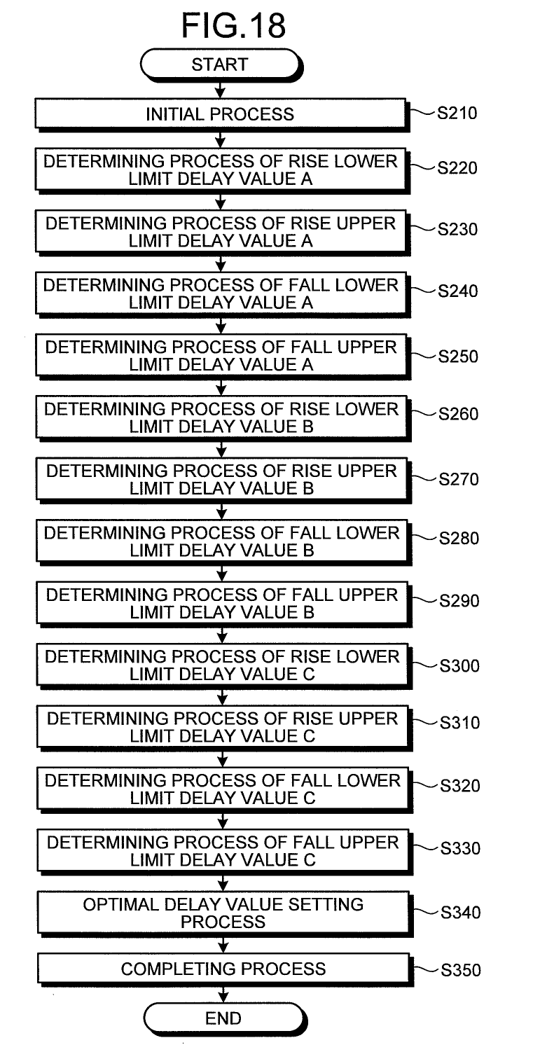

Next, a process sequence of a memory optimization setting process according to the second embodiment will be described with reference to FIG. 18. FIG. 18 is a flowchart illustrating a process sequence of a memory optimization setting process according to the second embodiment. In FIG. 18, each process is executed in the order of the drive strengths A, B, and C, but each process is almost the same as that in FIG. 7. Therefore, the description of the same process is not omitted.

First, the memory optimization setting process executes an initial process (S210).

Next, the memory optimization setting process executes a determining process of a rise lower limit delay value A and a determining process of a rise upper limit delay value A in order to determine the upper and lower limits of the rise edge of the DQS signal with respect to the drive strength A (S220 and S230). At this time, during the memory optimization setting process, the optimum rise value determining module 260a holds a difference of the rise lower limit delay value and the rise upper limit delay value in the read parameter optimization table 230c.

Next, the memory optimization setting process is executes a determining process of a fall lower limit delay value A and a determining process of a fall edge upper limit delay value A in order to determine the upper and lower limits of the fall edge of the DQS signal with respect to the drive strength A (S240 and S250). At this time, during the memory optimization setting process, the optimum fall value determining module 260b holds a difference of the fall lower limit delay value and the fall upper limit delay value in the read parameter optimization table 230c.

Next, the memory optimization setting process executes the above-described process using the drive strength A by a process using each drive strength in the order of the drive strengths B and C (S260 to S290 and S300 to S330).

Next, the memory optimization setting process executes the optimal delay value setting process (S340). Specifically, the memory optimization setting process selects the drive strength where the difference between the upper and lower limits of the rise delay values (or fall delay values) corresponding to the drive strengths A, B, and C is the maximum value. The memory optimization setting process sets the selected drive strength and the rise delay value and the fall delay value corresponding to the drive strength to the drive strength set value and the rise delay set value and the fall delay set value of the read parameter register 200, respectively, and sets the selected drive strength and the rise delay value and the fall delay value to the strength register 100a of the DDR-SDRAM 1, the DQS rise edge delay equivalent circuit 201, and the DQS fall edge delay equivalent circuit 202. The optimum value setting module 270 outputs an optimization completion message to the processor 3.

In addition, the memory optimization setting process executes a completing process (S350).

As such, according to the second embodiment, the memory control apparatus 4 determines a range of the delay time of the DQS signal for each of the rise edge and the fall edge of the DQS signal corresponding to each drive strength, using the different drive strengths. The memory control apparatus 4 selects the drive strength where the range of the delay time of the rise edge of the DQS signal or the range of the delay time of the fall edge of the DQS signal is maximal. The memory control apparatus 4 determines the delay time of the DQS signal for each of the rise edge and the fall edge of the DQS signal corresponding to the selected drive strength.

In this way, the memory control apparatus 4 changes the drive strength, and selects the drive strength where the range of the delay time of the rise edge or the fall edge of the DQS signal is maximized. The memory control apparatus 4 can maximize the timing margin where the DQ signal is received and optimize the reception timing of the DQ signal.

Meanwhile, in the first embodiment, when the optimization command is acquired from the processor 3, the delay time of the DQS signal for each of the rise edge and the fall edge of the DQS signal is determined. However, the invention is not limited thereto, and the delay time of the DQS signal for each of the rise edge and the fall edge of the DQS signal may be determined, when an error is generated in the data received from the DDR-SDRAM 1.

In the third embodiment, the description is given to the case where the delay time of the DQS signal for each of the rise edge and the fall edge of the DQS signal is determined when an error is generated in the data received from the DDR-SDRAM 1.

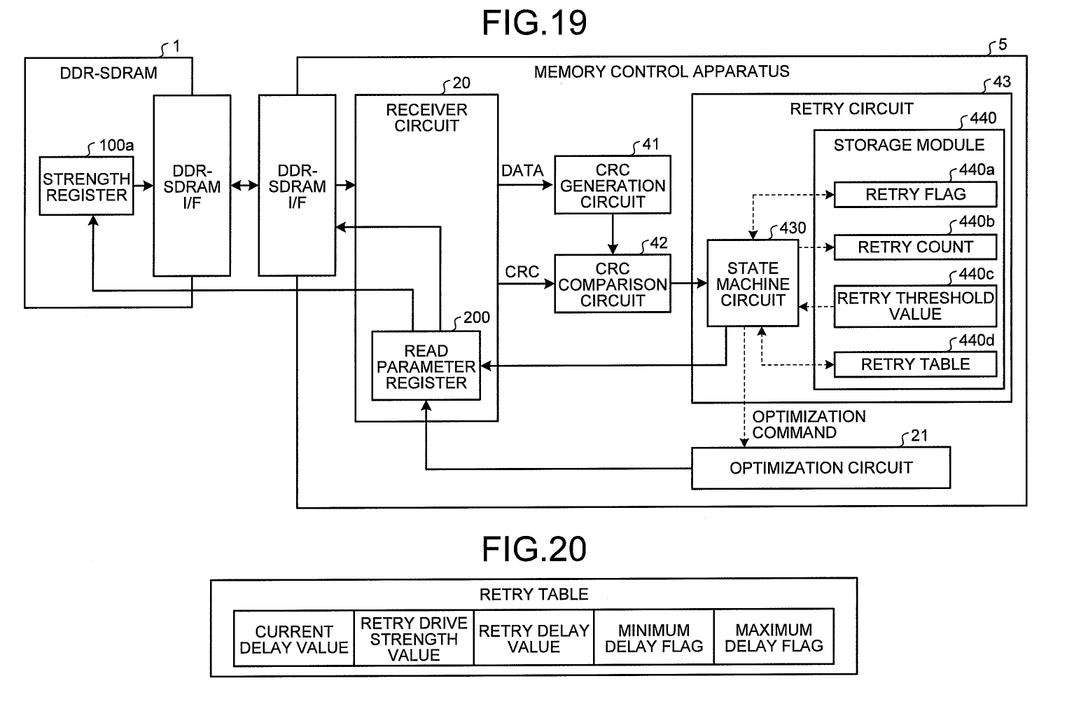

First, the configuration of a memory control apparatus according to the third embodiment will be described with reference to FIG. 19. FIG. 19 is a functional block diagram of the configuration of a memory control apparatus according to a third embodiment of the invention. As illustrated in FIG. 19, in a memory control apparatus 5 according to the third embodiment, in addition to the components of the memory control apparatus 2 (refer to FIG. 2) according to the first embodiment, a CRC generation circuit 41, a CRC comparison circuit 42, and a retry circuit 43 are added. The memory control apparatus 5 is connected to the DDR-SDRAM 1 through an interface DDR-SDRAM I/F. In FIG. 19, the same components as those in FIG. 2 are denoted by the same reference numerals and the repetitive description is omitted.

If the receiver circuit 20 receives data having a CRC (Cyclic Redundancy Check) added thereto from the DDR-SDRAM 1, the receiver circuit 20 outputs the received data to the CRC generation circuit 41, and outputs the CRC, which is added to the received data, to the CRC comparison circuit 42. In this case, it is assumed that the data having the added CRC is stored in the DDR-SDRAM 1.

If the CRC generation circuit 41 received data from the receiver circuit 20, the CRC generation circuit 41 calculates the CRC from the received data, and compares the calculated CRC to the CRC comparison circuit 42.

The CRC comparison circuit 42 receives the CRC from the receiver circuit 20 and receives the CRC from the CRC generation circuit 41, the CRC comparison circuit 42 compares the received CRCs. As the comparison result of the received CRCs, when it is determined that the CRCs are matched with each other, the CRC generation circuit 41 outputs a message indicating that the CRCs are matched with each other to a state machine circuit 430. Meanwhile, as the comparison result of the acquired CRCs, when it is determined that the CRCs are not matched with each other, the CRC generation circuit 41 outputs a message indicating that the CRCs are not matched with each other to the state machine circuit 430.

The retry circuit 43 comprises the state machine circuit 430 and a storage module 440. If the state machine circuit 430 receives the message indicating that the CRCs are matched with each other from the CRC comparison circuit 42, the state machine circuit 430 urges a CPU (not illustrated) to perform the subsequent operation. Meanwhile, if the state machine circuit 430 receives the message indicating that the CRCs are not matched with each other from the CRC comparison circuit 42, the state machine circuit 430 increases a retry count 440b indicating a retry execution count by 1. When the added retry count 440b is not more than a retry threshold value 440c indicating a threshold value of a retry count, the state machine circuit 430 reads the delay value and the drive strength value held in a retry table 440d, changes the read values, sets the delay value and the drive strength value to the read parameter register 200, the DQS delay equivalent circuit, and the strength register 100a of the DDR-SDRAM 1, and causes the CPU to execute the retry. Meanwhile, when the added retry count 440b is more than the retry threshold value 440c, the state machine circuit 430 outputs an optimization command to the optimization circuit 21. Thereby, the state machine circuit 430 can set, to the read parameter register 200, the delay time of the DQS signal for each of the rise edge and the fall edge of the DQS signal on the basis of a newest environment. Therefore, the state machine circuit 430 can suppress a corrupted data error from being generated, after the delay time is set.

The storage module 440 comprises a retry flag 440a, the retry count 440b, the retry threshold value 440c, and the retry table 440d. The retry flag 440a holds whether the retry starts. For example, the retry flag 440a holds 0 when the retry does not start and 1 when the retry starts. The retry count 440b holds a retry execution count. As the retry threshold value 440c, a maximum value of an allowable retry count is held. When the retry is executed, the retry table 440d holds the drive strength value and the delay value set to the read parameter register 200.

Next, a data structure of the retry table 440d according to the third embodiment will be described with reference to FIG. 20. As illustrated in FIG. 20, the retry table 440d holds a current delay value, a retry drive strength value, a retry delay value, a minimum delay flag, and a maximum delay flag. The current delay value indicates a delay value of a DQS signal before starting a retry, and is in a range of 1 to 9 (unit:clock). The retry drive strength value indicates a drive strength value of the DDR-SDRAM 1 at the time of the retry. The retry delay value indicates a delay value of the DQS signal at the time of the retry, and is in a range of 0 to 9 (unit:clock). The minimum delay flag indicates whether the delay value of the DQS signal is changed up to a minimum value, and is “0” when the delay value is not changed up to the minimum value and “1” when the delay value is changed to the minimum value. The maximum delay flag indicates whether the delay value of the DQS signal is changed up to a maximum value, and is “0” when the delay value is not changed up to the maximum value and “1” when the delay value is changed up to the maximum value. In the retry delay value, a delay value is held without discriminating the rise edge and the fall edge of the DQS signal from each other. However, a delay value for each of the rise edge and the fall edge of the DQS signal may be held.

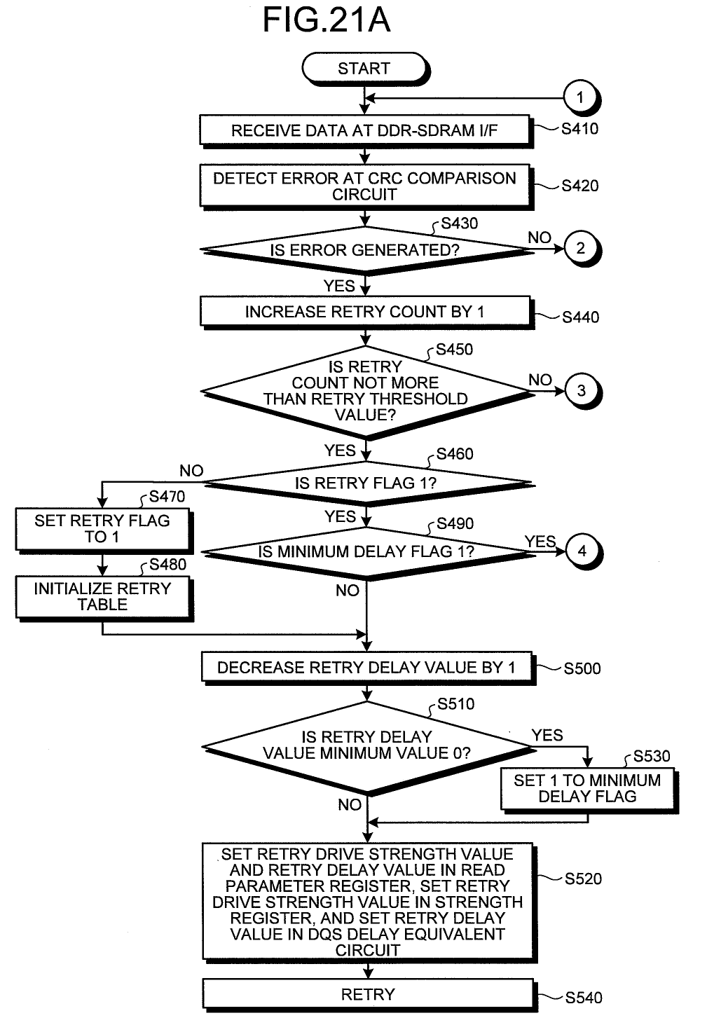

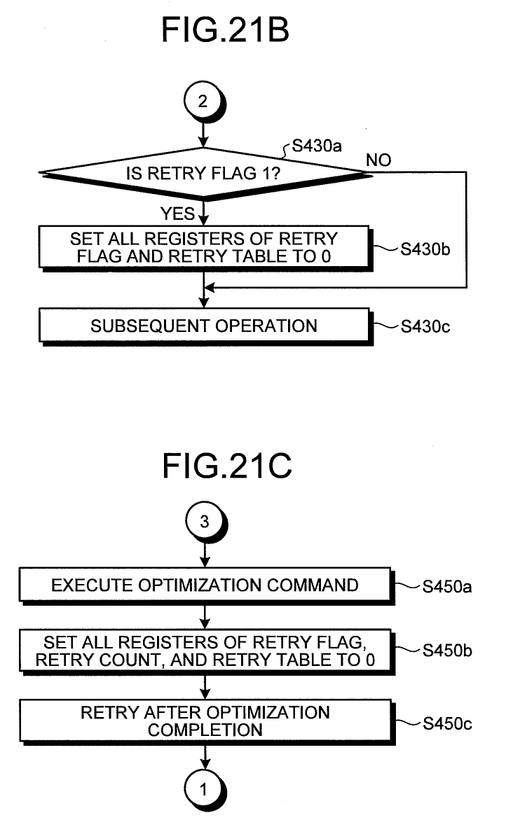

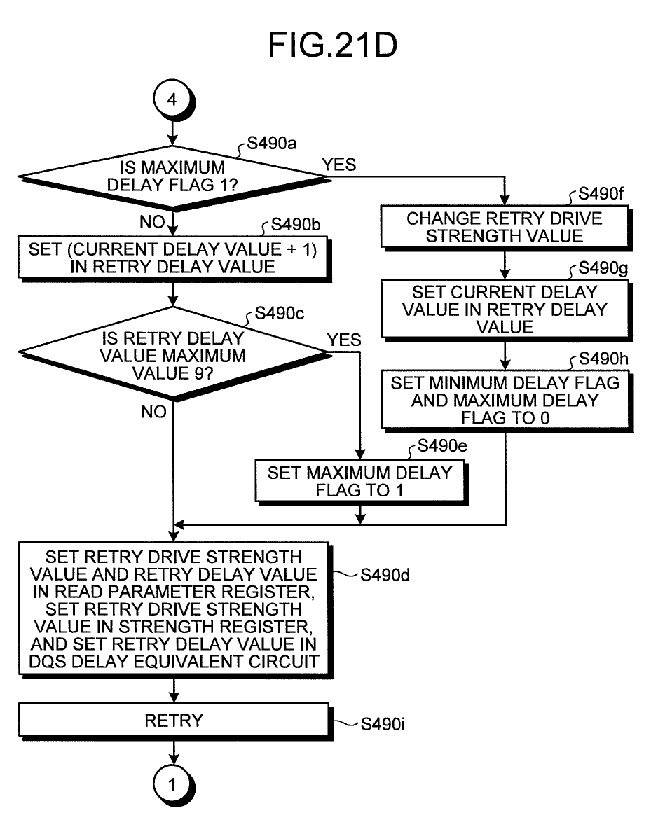

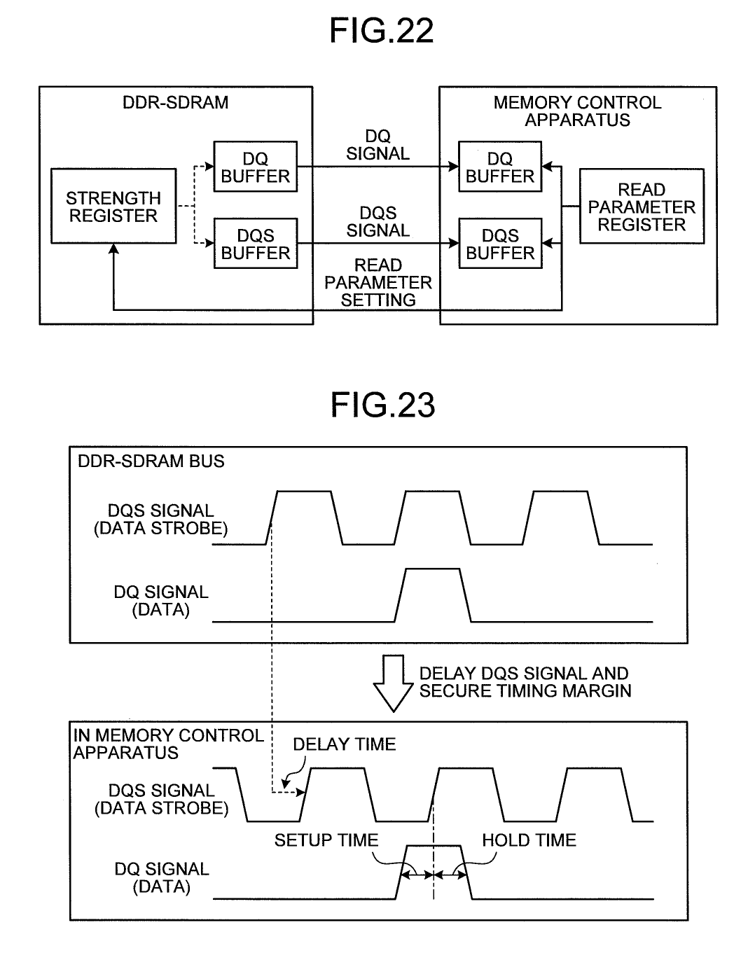

Next, a process sequence of a memory optimization setting process according to a third embodiment will be described with reference to FIGS. 21A to 21D.

First, the receiver circuit 20 outputs a data read command to the DDR-SDRAM 1. The receiver circuit 20 receives data with respect to the data read command through a DDR-SDRAM I/F (S410). At this time, the receiver circuit 20 receives a CRC that is added to the data.

In addition, the CRC generation circuit 41 generates a CRC from the data received by the receiver circuit 20, and outputs the CRC to the CRC comparison circuit 42. The CRC comparison circuit 42 compares the CRC received by the receiver circuit 20 and the CRC generated by the CRC generation circuit 41 (S420 and S430).

When the CRC received by the receiver circuit 20 is not matched with the CRC generated by the CRC generation circuit 41 (Yes at S430), the state machine circuit 430 adds the retry count 440b by 1 (S440), and determines whether the retry count 440b is not more than the retry threshold value 440c (S450). Meanwhile, when the CRC received by the receiver circuit 20 coincides with the CRC generated by the CRC generation circuit 41 (No at S403), the data is normally read. Therefore, the state machine circuit 430 proceeds to a “subsequent operation process”.

Next, when the retry count 440b is more than the retry threshold value 440c (No at S450), the state machine circuit 430 maximally executes the retry. Therefore, the state machine circuit 430 proceeds to an “optimizing process” for optimizing the delay value of the DQS signal.

Meanwhile, when the retry count 440b is not more than the retry threshold value 440c (Yes at S450), the state machine circuit 430 determines whether the retry flag 440a is “1” indicating a start of the retry (S460).

When the retry flag 440a is not “1” (No at S460), the state machine circuit 430 sets the retry flag to “1” (S470), and initializes the retry table 440d (S480). Specifically, the state machine circuit 430 sets a drive strength set value of the read parameter register 200 to a retry drive strength value of the retry table 440d, and sets the delay value of the DQS signal of the read parameter register 200 to the current delay value and the retry delay value of the retry table 440d.

Meanwhile, when the retry flag 440a is “1” (Yes at S460), the state machine circuit 430 determines whether a minimum delay flag of the retry table 440d is “1” in order to confirm whether the retry is executed up to the minim value of the delay value (S490). When the minimum delay flag is “1”, the retry is executed up to the minimum value of the delay value. Therefore, the state machine circuit 430 proceeds to a “subsequent retry process”.

Meanwhile, when the minimum delay flag of the retry table 440d is not “1” (No at S490), the state machine circuit 430 subtracts the retry delay value by a predetermined value (for example, 1 clock) (S500), and determines whether the retry delay value is a minimum value (for example, “0”) (S510). When the retry delay value is the minimum value (for example, “0”) (Yes at S510), the state machine circuit 430 sets “1” to the minimum delay flag of the retry table 440d (S530).

When the retry delay value is not the minimum value (for example, “0”) (No at S510), the state machine circuit 430 sets the retry drive strength value and the retry delay value of the retry table 440d to the read parameter register 200, the strength register 100a of the DDR-SDRAM 1, and the DQS delay equivalent circuit (S520), and executes the retry (S540).

Next, a process sequence of the “subsequent operation process” in the memory optimization setting process according to the third embodiment will be described with reference to FIG. 21B.

When the data is normally read, the state machine circuit 430 determines whether the retry flag 440a is “1” (S430a). When it is determined that the retry flag 440a is “1”, the state machine circuit 430 sets the retry flag 440a, the retry count 440b, and the retry table 440d to 0 (S430b).

In order to urge the CPU to execute the subsequent operation, the state machine circuit 430 outputs a message indicating that the data has been normally read to the CPU (S430c).

Next, a process sequence of the “optimizing process” in the memory optimization setting process according to the third embodiment will be described with reference to FIG. 21C.

When the retry count is maximal, the state machine circuit 430 outputs an optimization command to the optimization circuit 21 (S450a).

In addition, the state machine circuit 430 sets the retry flag 440a, the retry count 440b, and the retry table 440d to an initial value (for example, “0) (S450b).

When the state machine circuit 430 receives an optimization completion from the optimization circuit 21, the state machine circuit 430 executes the retry (S450c). The memory optimization setting process is subsequently executed.

Next, a process sequence of the “subsequent retry process” in the memory optimization setting process according to the third embodiment will be described with reference to FIG. 21D.

When the retry is executed up to the minimum value of the delay value, the state machine circuit 430 determines whether a maximum delay flag of the retry table 440d is “1” in order to confirm whether the retry is executed up to the maximum value of the delay value (S490a). When the maximum delay flag is not “1” (No at S490a), the retry is not executed up to the maximum value of the delay value. Therefore, the state machine circuit 430 sets a value, which is obtained by adding the current delay value by a predetermined value (for example, 1 clock), to the retry delay value (S490b), and confirms whether the retry delay value is 9 corresponding to the maximum value (S490c). When the retry delay value is the maximum value (for example, 9 clocks) (Yes at S490c), the state machine circuit 430 sets “1” to the maximum delay flag of the retry table 440d (S490e).

Meanwhile, when the maximum delay flag is “1” (Yes at S490a), the state machine circuit 430 changes the retry drive strength value of the retry table 440d to a value different from the current held value (S490f). At this time, in order to initialize a value other than the retry drive strength value of the retry table 440d, the state machine circuit 430 sets the current delay value to the retry delay value (S490g), and sets the minimum delay flag and the maximum delay flag to “0” (S490h).

When the retry delay value is not the maximum value (for example, 9 clocks) (No at S490c) or the retry drive strength value is changed (S490f), the state machine circuit 430 sets the retry drive strength value and the retry delay value of the retry table 440d to the read parameter register 200, the strength register 100a of the DDR-SDRAM 1, and the DQS delay equivalent circuit (S490d), and executes the retry (S490i). The memory optimization setting process is subsequently executed.

The memory optimization setting process decreases the delay value of the DQS signal from the current delay value to the minimum value, and increases the delay value of the DQS signal from the current delay value to the maximum value, but the invention is not limited thereto. For example, the memory optimization setting process may decrease the current delay value by “1” and increase the current delay value by “1”, and decrease the current delay value by “2” and increase the current delay value by “2”.

As such, according to the third embodiment, when the data received from the DDR-SDRAM 1 is abnormal, the memory control apparatus 5 sets the delay time of the rise edge of the DQS signal or the delay time of the fall edge of the DQS signal to the read parameter register 200 again such that the delay time is different from the delay time at the time of reception. When the data received from the DDR-SDRAM 1 is abnormal, the memory control apparatus 5 sets the drive strength value to the read parameter register 200 again such that drive strength value is different from the drive strength value at the time of reception.

In this way, when a corrupted data error is generated in the data received from the DDR-SDRAM 1, the memory control apparatus 5 automatically changes the delay time of the rise edge or the fall edge of the DQS signal to the delay time different from the delay time at the time of the reception. Therefore, if the retry is executed after the delay time is changed, the possibility of the data being recovered becomes high, and generation of the corrupted data error can be suppressed with respect to the reception after the recovery. When the corrupted data error is generated in the data received from the DDR-SDRAM 1, the memory control apparatus 5 automatically changes the drive strength value to the value different from the value at the time of the reception, the memory control apparatus 5 can cope with the deterioration of the reception timing of the DQ signal due to a temperature environment, and can appropriately secure the reception timing of the DQ signal at all times.

Each of the memory control apparatus 2 and the memory control apparatus 4 generates the different DQS signals for each of the rise edge and the fall edge of the DQS signal using the DQS rise edge delay equivalent circuit 201 and the DQS fall edge delay equivalent circuit 202, and sets the delay time where the corrupted data error is not generated in the data extracted from the DQ signal synchronized with the DQS signal to the rise delay set value and the fall delay set value of the read parameter register 200, but the invention is not limited thereto. For example, each of the memory control apparatus 2 and the memory control apparatus 4 may generate the different DQS signals using any one of the DQS rise edge delay equivalent circuit 201 and the DQS fall edge delay equivalent circuit 202, and determine the delay time where the corrupted data error is not generated in the data extracted from the DQ signal synchronized with the DQS signal, for each of the rise edge and the fall edge of the DQS signal, and set the delay time to the rise delay set value and the fall delay set value of the read parameter register 200 corresponding to the delay time.

A portion or all of the various process functions that are executed by the memory control apparatus 2, the memory control apparatus 4, and the memory control apparatus 5 may be realized by a micro computer, such as a Center Processing Unit (CPU), a Micro Processing Unit (MPU), and a Micro Controller Unit (MCU) and a program analyzed and executed by the CPU (or the micro computer, such as the MPU and the MCU), or may be realized as hardware based on wired logic.

According to embodiments of the memory control apparatus, and the memory optimization program and method, it is possible to infallibly receive correct data from a DQ signal at timings of a rise edge and a fall edge of a DQS signal.

The various modules of the systems described herein can be implemented as software applications, hardware and/or software modules, or components on one or more computers, such as servers.

While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A memory control apparatus, comprising:
a delay generator configured to delay a clock signal comprising a rise portion and a fall portion that appear in a predetermined cycle and to generate a plurality of delay clock signals comprising delay times different from each other;
an extracting module configured to extract data of a portion from a data signal comprising predetermined reference data, the portion corresponding to either the rise or fall portion of the generated delay clock signals;
a first determining module configured to determine whether the extracted data coincides with the reference data; and
a second determining module configured to determine a range of the delay time with respect to the rise portion of the clock signal and a range of the delay time with respect to the fall portion of the clock signal, from the delay times of the delay clock signals corresponding to the data that have been determined by the determining module to coincide.

2. The memory control apparatus of claim 1, wherein
the delay generator is configured to generate two delay clock signals with respect to a plurality of delay times,
the extracting module comprises:
a first extractor configured to extract data of a portion corresponding to a rise portion of a first delay clock signal from the data signal comprising predetermined reference data; and
a second extractor configured to extract data of a portion corresponding to a fall portion of the second delay clock signals from the data signal comprising predetermined reference data,
the first determining module determines whether the data corresponds to the rise portion of the first delay signal extracted by the first extracting module or the data corresponds to the fall portion of the second delay clock signal extracted by the second extracting module coincides with the reference data, and
the second determining module comprises:
a first determiner configured to determine a range of the delay time with respect to the rise portion of the clock signal, from the delay time of the first clock delay signal corresponding to the data that has been determined by the first determining module to coincide, and
a second determiner configured to determine a range of the delay time with respect to the fall portion of the clock signal, from the delay time of the second delay clock signal corresponding to the data that has been determined by the first determining module to coincide.

3. The memory control apparatus of claim 1, further comprising a receiver configured to receive data using an intermediate delay time in the range of the delay time with respect to the rise portion of the clock signal determined by the second determining module and an intermediate delay time in the range of the delay time with respect to the fall portion of the clock signal determined by the second determining module.

4. The memory control apparatus of claim 3, wherein
the delay generator is configured to delay a plurality of clock signals comprising different amplitude values indicative of strengths of the clock signals to generate a plurality of delay clock signals comprising delay times different from each other,
the second determining module is configured to determine a range of a delay time with respect to a rise portion of a clock signal and a range of a delay time with respect to a fall portion of the clock signal for each amplitude value, and
the receiver comprises an amplitude selecting module configured to select an amplitude value corresponding to a substantially maximum range of the delay time from the range of the delay time with respect to the rise portion of the clock signal or the range of the delay time with respect to the fall portion of the clock signal determined for each amplitude value by the second determining module, and to receive data using the amplitude value selected by the amplitude selecting module and the delay time corresponding to the selected amplitude value.

5. The memory control apparatus of claim 3, wherein the delay generator is configured to delay a clock signal to generate a plurality of delay clock signals comprising delay times different from each other, if the data received by the receiver is abnormal.

6. The memory control apparatus of claim 3, further comprising a re-receiver configured to receive the data again using a second delay time different from the delay time used when the data was received, if the data received by the receiver is abnormal.

7. The memory control apparatus of claim 6, wherein the re-receiver is configured to receive the data again using a second amplitude value different from the amplitude value used when the data was received.

8. A computer program product for memory optimization comprising a computer readable medium comprising programmed instructions, wherein the instructions, when executed by a computer, cause the computer to:
generate a plurality of delay clock signals comprising delay times different from each other by delaying a clock signal comprising a rise portion and a fall portion that appear in a predetermined cycle;
extracting data of portions from a data signal comprising predetermined reference data, the portions corresponding to the rise or fall portions of generated delay clock signals;
first determining whether each data extracted coincides with the reference data; and
second determining a range of the delay time with respect to the rise portion of the clock signal and a range of the delay time with respect to the fall portion of the clock signal from the delay times of the delay clock signals corresponding to the data that have been determined in the first determining to coincide.

9. A memory optimization method, comprising:
generating a plurality of delay clock signals comprising delay times different from each other by delaying a clock signal having a rise portion and a fall portion that appear in a predetermined cycle;
extracting data of portions corresponding to the rise or fall portions of generated delay clock signals, from a data signal comprising predetermined reference data;
first determining whether each data extracted coincides with the reference data; and
second determining a range of the delay time with respect to the rise portion of the clock signal and a range of the delay time with respect to the fall portion of the clock signal from the delay times of the delay clock signals corresponding to the data that have been determined in the first determining to coincide.
